(19) United States
(12) Patent Application Publication
(10) Pub. No.: US 2026/0149588 A1
(43) Pub. Date: May 28, 2026

(54) ZERO-KNOWLEDGE PROOF OF REGULATORY COMPLIANCE FOR ARTIFICIAL INTELLIGENCE WITH TRUST-STATE ORCHESTRATION

(71) Applicant: George William Bickerstaff, III, Greenwich, CT (US)

(72) Inventor: George William Bickerstaff, III, Greenwich, CT (US)

(21) Appl. No.: 19/452,970

(22) Filed: Jan. 20, 2026

(51) Int. Cl. H04L 9/32

(52) U.S. Cl. CPC H04L 9/3218

(57) ABSTRACT

A system for zero-knowledge proof of regulatory compliance for artificial intelligence model deployment encodes regulatory requirements into compliance predicates, generates and verifies zero-knowledge proofs without disclosure of protected information, updates a trust state, and enforces execution across jurisdictions and vendors while preserving privacy and intellectual property.

### TECHNICAL FIELD

The present invention relates to computer-implemented systems for regulatory compliance, governance, and verification of artificial intelligence systems.

More particularly, the invention relates to systems and methods for generating and verifying zero-knowledge proofs demonstrating regulatory compliance of artificial intelligence models without disclosure of protected information, and for enforcing execution, access, and interoperability through trust-state orchestration.

### BACKGROUND

Artificial intelligence systems are increasingly deployed in regulated environments including healthcare, finance, insurance, critical infrastructure, and cross-border data ecosystems.

Regulatory frameworks governing such deployments require demonstrable compliance with safety, privacy, fairness, accountability, and operational constraints.

Conventional compliance verification mechanisms require disclosure of training data, model parameters, validation results, or proprietary logic, creating unacceptable risks to intellectual property, privacy, and competitive advantage.

Existing audit-based or privacy-preserving approaches do not provide a system-level mechanism for cryptographically proving compliance while simultaneously enforcing execution decisions in operational environments.

Accordingly, there exists a need for a technical system that enables regulatory compliance to be proven without disclosure and enforced through automated, cryptographically verifiable governance mechanisms.

### SUMMARY OF THE INVENTION

The invention provides a computer-implemented system that encodes regulatory requirements into compliance predicates, generates zero-knowledge proofs demonstrating satisfaction of those predicates, verifies the proofs, and enforces execution using a trust-state orchestration system.

Verified compliance proofs are combined with quantified trust attributes to dynamically govern deployment, execution, access, and interoperability of artificial intelligence models across jurisdictions and vendors.

### BRIEF DESCRIPTION OF THE DRAWINGS

FIG. 1 illustrates an overall system architecture for zero-knowledge regulatory compliance and governance of artificial intelligence models.

FIG. 2 illustrates creation, encoding, versioning, and distribution of compliance manifests representing regulatory requirements.

FIG. 3 illustrates generation and aggregation of zero-knowledge proofs demonstrating regulatory compliance without disclosure of protected information.

FIG. 4 illustrates verification of compliance proofs and enforcement of governance decisions based on verification results.

FIG. 5 illustrates trust-state orchestration governing execution, interoperability, and continuous compliance of artificial intelligence models.

### DETAILED DESCRIPTION OF THE DRAWINGS

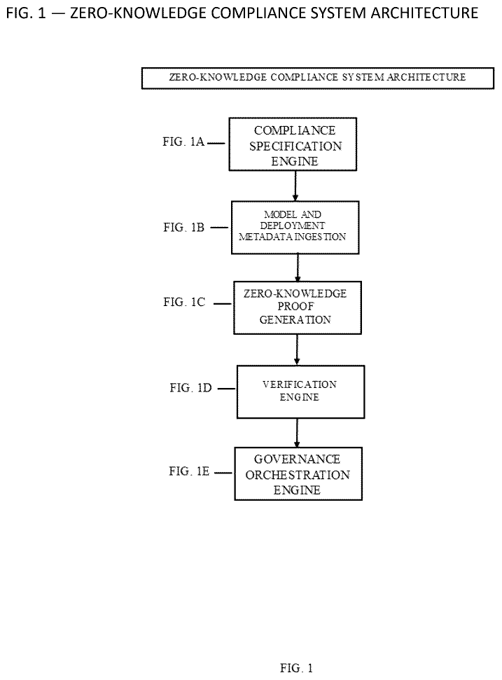

### FIG. 1—Zero-Knowledge Compliance System Architecture

FIG. 1 illustrates an overall system architecture for zero-knowledge regulatory compliance verification. The architecture depicts coordinated engines for compliance specification, proof generation, verification, and governance enforcement. Protected model data is cryptographically isolated throughout the system.

### FIG. 1A—Compliance Specification Engine

FIG. 1A illustrates a compliance specification engine configured to encode regulatory frameworks into machine-readable compliance predicates. Regulatory requirements are normalized and versioned to support auditability and jurisdiction-specific enforcement. The engine produces compliance manifests consumed by downstream components.

### FIG. 1B—Model and Deployment Metadata Ingestion

FIG. 1B illustrates ingestion of model metadata and deployment context information. Sensitive attributes are represented using cryptographic commitments rather than raw disclosure. The metadata enables evaluation of compliance predicates without revealing protected information.

### FIG. 1C—Zero-Knowledge Proof Generation Engine

FIG. 1C illustrates a proof generation engine that constructs zero-knowledge proofs demonstrating satisfaction of compliance predicates. Proof generation occurs without exposing training data, model parameters, or proprietary logic. The engine supports regeneration as requirements or deployment contexts change.

### FIG. 1D—Verification Engine

FIG. 1D illustrates a verification engine configured to validate zero-knowledge proofs against compliance manifests and public verification keys. Verification produces deterministic and repeatable results suitable for regulatory review. No protected information is disclosed during verification.

### FIG. 1E—Governance Orchestration Engine

FIG. 1E illustrates a governance orchestration engine that enforces deployment and execution decisions based on verified proofs. The engine permits, restricts, or denies operation of artificial intelligence models. Cryptographically signed governance receipts are generated for audit and evidentiary purposes.

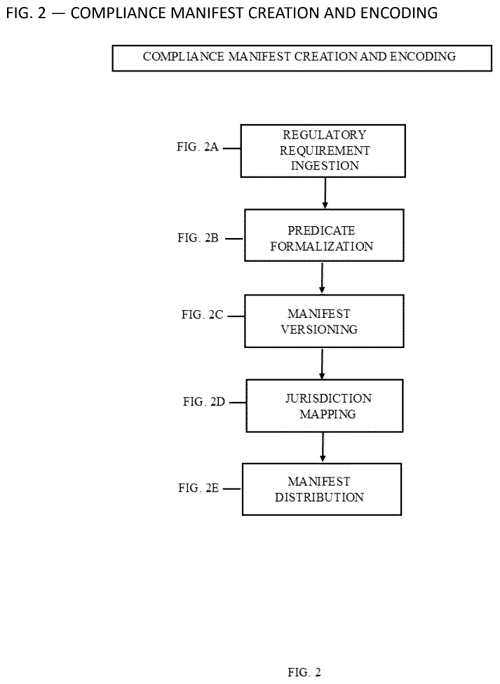

### FIG. 2—Compliance Manifest Creation and Encoding

FIG. 2 illustrates creation and management of compliance manifests. Regulatory requirements are transformed into structured artifacts usable by cryptographic proof systems. Manifests enable scalable and repeatable compliance verification.

### FIG. 2A—Regulatory Requirement Ingestion

FIG. 2A illustrates ingestion of regulatory texts, standards, and policy rules from authoritative sources. Requirements are parsed and normalized into formal representations. Updates are tracked to preserve historical traceability.

### FIG. 2B—Predicate Formalization

FIG. 2B illustrates transformation of regulatory requirements into mathematically verifiable compliance predicates. Predicates express conditions relating to safety, privacy, fairness, and performance. Predicate logic supports reuse across multiple regulatory frameworks.

### FIG. 2C—Manifest Versioning

FIG. 2C illustrates versioning of compliance manifests over time. Versioning supports regulatory evolution and retrospective audits. Past compliance states remain verifiable.

### FIG. 2D—Jurisdiction Mapping

FIG. 2D illustrates mapping of compliance predicates to jurisdiction-specific regulatory regimes. A single artificial intelligence model may be evaluated across multiple jurisdictions simultaneously. Duplicate disclosure is avoided.

### FIG. 2E—Manifest Distribution

FIG. 2E illustrates secure distribution of signed compliance manifests. Manifests are cryptographically protected against tampering. Trust in downstream verification outcomes is preserved.

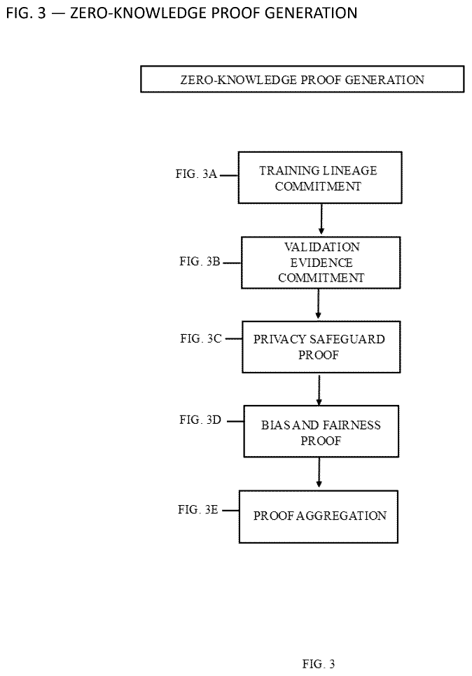

### FIG. 3—Zero-Knowledge Proof Generation

FIG. 3 illustrates generation of zero-knowledge proofs demonstrating regulatory compliance. Proofs are generated without revealing protected information. Aggregation enables efficient verification.

### FIG. 3A—Training Lineage Commitment

FIG. 3A illustrates cryptographic commitment to training data provenance. Commitments demonstrate compliance with data sourcing requirements. Raw training data remains confidential.

### FIG. 3B—Validation Evidence Commitment

FIG. 3B illustrates commitment to validation outcomes such as accuracy and robustness. Proofs demonstrate threshold satisfaction without exposing validation datasets. Regulatory assurance is preserved.

### FIG. 3C—Privacy Safeguard Proof

FIG. 3C illustrates proof of implemented privacy safeguards. Compliance with data protection requirements is demonstrated cryptographically. Sensitive personal data is not disclosed.

### FIG. 3D—Bias and Fairness Proof

FIG. 3D illustrates proof that bias and fairness constraints are satisfied. Equity thresholds are proven without revealing protected attributes. Continuous fairness governance is supported.

### FIG. 3E—Proof Aggregation

FIG. 3E illustrates aggregation of multiple zero-knowledge proofs into a composite proof. Aggregation reduces verification overhead. End-to-end compliance is efficiently demonstrated.

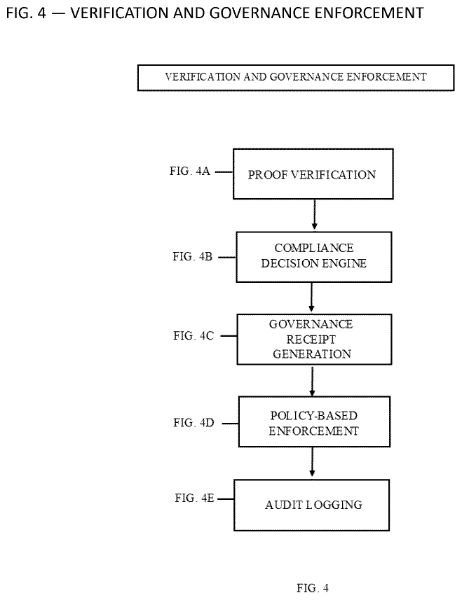

### FIG. 4—Verification and Governance Enforcement

FIG. 4 illustrates verification of compliance proofs and enforcement of governance decisions. Verified results directly control execution. All actions are auditable.

### FIG. 4A—Proof Verification

FIG. 4A illustrates cryptographic verification of zero-knowledge proofs. Verification confirms satisfaction of compliance predicates. Results are deterministic.

### FIG. 4B—Compliance Decision Engine

FIG. 4B illustrates evaluation of verification results to produce compliance decisions. Decisions may approve, conditionally approve, or deny execution. Policies are applied consistently.

### FIG. 4C—Governance Receipt Generation

FIG. 4C illustrates generation of cryptographically signed governance receipts. Receipts provide durable evidence of compliance. Receipts support audits and dispute resolution.

### FIG. 4D—Deployment Context Enforcement

FIG. 4D illustrates enforcement of execution constraints based on verified deployment context. Jurisdictional and operational limitations are enforced automatically. Unauthorized execution is prevented.

### FIG. 4E—Audit Logging

FIG. 4E illustrates immutable logging of verification and enforcement events. Logs preserve evidentiary integrity. Regulatory review is simplified.

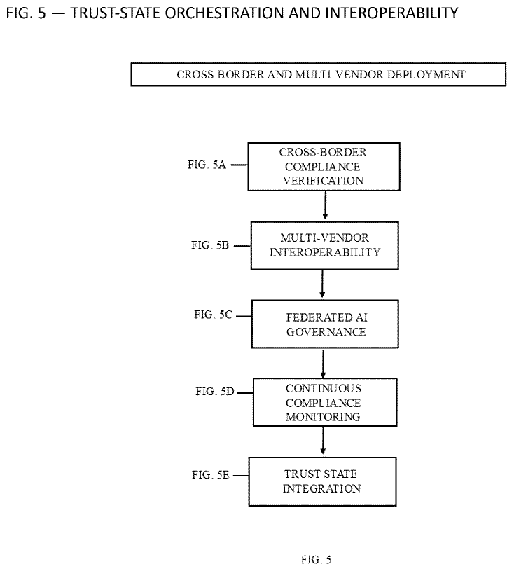

### FIG. 5—Trust-State Orchestration and Interoperability

FIG. 5 illustrates trust-state orchestration governing execution of artificial intelligence models. Trust states integrate compliance proofs and trust attributes. Execution is conditionally enabled.

### FIG. 5A—Trust Attribute Ingestion

FIG. 5A illustrates ingestion of quantified trust attributes. Trust attributes may represent authority, credibility, or verification status. Attributes are machine-readable.

### FIG. 5B—Trust State Update

FIG. 5B illustrates dynamic updating of trust states. Trust states evolve based on verification, revocation, or expiration. Historical trust transitions are preserved.

### FIG. 5C—Execution Gating

FIG. 5C illustrates gating of execution based on trust state. Models execute only when trust conditions are satisfied. Enforcement is automatic.

### FIG. 5D—Continuous Compliance Monitoring

FIG. 5D illustrates continuous monitoring for model drift or context change. Re-verification is triggered automatically. Compliance remains current.

### FIG. 5E—Cross-System Interoperability

FIG. 5E illustrates interoperability across platforms and vendors using trust states. Execution eligibility is communicated securely. Proprietary information remains protected.

1. A computer-implemented system for regulatory compliance of artificial intelligence model deployment, comprising:
a compliance specification engine configured to encode regulatory requirements into compliance predicates;
a proof generation engine configured to generate zero-knowledge proofs demonstrating satisfaction of the compliance predicates without revealing protected information;
a verification engine configured to verify the zero-knowledge proofs; and
a governance orchestration engine configured to control execution based on verification results.

2. A computer-implemented method comprising encoding regulatory requirements into compliance predicates, generating zero-knowledge proofs demonstrating satisfaction of the predicates, verifying the proofs, updating a trust state, and enforcing execution of an artificial intelligence model based on the trust state.

3. A computer-implemented system comprising a trust-state orchestration engine configured to receive verified zero-knowledge compliance proofs and quantified trust attributes, update a trust state, and govern execution, access, or interoperability of an artificial intelligence model.

4. The system of claim 1, wherein the compliance predicates include training data provenance requirements.

5. The system of claim 1, wherein the compliance predicates include validation performance thresholds.

6. The system of claim 1, wherein the compliance predicates include privacy safeguard requirements.

7. The system of claim 1, wherein the compliance predicates include bias or fairness constraints.

8. The system of claim 1, wherein aggregated zero-knowledge proofs represent satisfaction of multiple compliance predicates.

9. The system of claim 3, wherein execution is permitted only while the trust state remains valid.

10. The method of claim 2, wherein compliance is evaluated across multiple jurisdictions simultaneously.
